(19) United States
(12) Patent Application Publication
(10) Pub. No.: US 2026/0025665 A1
(43) Pub. Date: Jan. 22, 2026

(54) USER TERMINAL AND METHOD OF CONTROLLNG THE SAME

(71) Applicant: LG ELECTRONICS INC., Seoul (KR)

(72) Inventors: Guwan JUNG, Seoul (KR); Dongwoo SOHN, Seoul (KR); Wonho KI, Seoul (KR); Jeongmin HONG, Seoul (KR)

(73) Assignee: LG ELECTRONICS INC., Seoul (KR)

(21) Appl. No.: 19/266,564

(22) Filed: Jul. 11, 2025

(30) Foreign Application Priority Data
Jul. 18, 2024 (WO) PCT/KR2024/010350

(51) Int. Cl. H04W 12/50; G06V 10/94; G06V 20/20; H04W 4/80; H04W 12/08

(52) U.S. Cl. CPC H04W 12/50; G06V 10/95; G06V 20/20; H04W 4/80; H04W 12/08; G06V 2201/02

(57) ABSTRACT

The present disclosure relates to a user terminal and method of controlling the same for providing a simple and securable communication connection system among user terminals, and the user terminal includes a camera, a wireless communication unit to communicate with an external user terminal, and a controller configured to photograph a screen currently displayed by a first external user terminal among a plurality of external user terminals through the camera, transmit photographed image information to a server or the first external user terminal, and control to access the first external user terminal based on access information received from the management server or the first external user terminal.

### CROSS-REFERENCE TO RELATED APPLICATION

Pursuant to 35 U.S.C. § 119, this application claims the benefit of an earlier filing date and right of priority to International Application No. PCT/KR2024/010350, filed on Jul. 18, 2024, the contents of which are hereby incorporated by reference herein in its entirety.

### BACKGROUND OF THE DISCLOSURE

### Field of the Disclosure

The present disclosure relates to a user terminal capable of communicating with other user terminals and method of controlling the same.

### Discussion of the Related Art

User terminals may be generally classified as mobile/portable terminals or stationary terminals according to their mobility. User terminals may also be classified as handheld terminals or vehicle mounted terminals according to whether or not a user can directly carry the terminal.

User terminals have become increasingly more functional. Examples of such functions include data and voice communications, capturing images and video via a camera, recording audio, playing music files via a speaker system, and displaying images and video on a display. Some user terminals include additional functionality which supports game playing, while other terminals are configured as multimedia players. More recently, user terminals have been configured to receive broadcast and multicast signals which permit viewing of content such as videos and television programs.

User terminals may be configured as multimedia players capable of performing various functions such as capturing images and video, recording audio, playing music files and outputting music, displaying images and videos, playing games, receiving broadcasts, and so on.

On the other hand, Virtual Reality (VR) technology provides objects, backgrounds, and the like in the real world only as computer graphic (CG) images, Augmented Reality (AR) technology provides virtual CG images on real object images, and Mixed Reality (MR) technology is a computer graphic technology that mixes and combines virtual objects with the real world. VR, AR, MR, and the like described above are all simply referred to as Extended Reality (XR) technology.

XR technology is applicable to Head-Mount Displays (HMDs), Head-Up Displays (HUDs), glasses-type glasses, mobile phones, tablet PCs, laptops, desktops, TVs, digital signage, etc., and devices to which XR technology is applied may be referred to as XR devices.

The XR device as described above is a display for displaying information, and may be equipped with a transparent display. Through the transparent display, a user may see an object of the real world located across the transparent display, and also see information provided by the extended reality device through the transparent display.

The XR device may also be understood as a kind of user terminal.

Recently, XR devices are increasingly operated in communication connection with other user terminals, such as laptops, mobile terminals, etc. For example, the XR device may transmit multimedia content that the device plays to another user terminal, or may receive and display multimedia content from another user terminal.

From user's point of view, there are more frequent cases in which the XR device needs to be communicatively connected with another user terminal. Therefore, research on a communication connection system that may conveniently guarantee security between the XR device and another user terminal is needed.

### SUMMARY OF THE DISCLOSURE

The present disclosure is proposed to solve this problem, and one object of the present disclosure is to provide a user terminal and method of controlling the same that may provide a simple and secure communication connection system between user terminals.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, a user terminal according to the present disclosure may include a camera, a wireless communication unit to communicate with an external user terminal, and a controller configured to photograph a screen currently displayed by a first external user terminal among a plurality of external user terminals through the camera, transmit photographed image information to a management server or the first external user terminal, and automatically access the first external user terminal based on access information received from the management server or the first external user terminal.

The controller may receive the access information from the management server or the first external user terminal based on approving image identity between the photographed image information and a first recorded image information of the first external user terminal.

Based on the first external user terminal related to a type of a wireless communication connectible device by recognizing the first external user terminal as an object, the controller may control the photographed image information to be transmitted to the management server or the first external user terminal.

The photographed image information may include at least one of a photographed video for a reference time, a reference number of photographed image frames, or an image hash value of a photographed image frame.

The controller may control the photographed image information to be transmitted together with surrounding environment information.

The surrounding environment information may include a surrounding searchable wireless Wi-Fi Access Point (AP) list.

The photographed image information may include a first feature pattern of the first external user terminal.

The controller may control the user terminal to be registered at a user account in the management server.

The first external user terminal may be registered at the same user account in the management server.

The access information may include an Internet Protocol (IP) address and port number for accessing the first external user terminal.

The controller may perform a first Bluetooth Low Energy (BLE) connection with the first external user terminal based on a first BLE advertisement signal received from the first external user terminal, and the controller may perform a second BLE connection with a second external user terminal based on a second BLE advertisement signal received from a second external user terminal among a plurality of the external user terminals.

The controller may transmit the photographed image information to the first external user terminal through the first BLE connection with the first external user terminal, and the controller may transmit the photographed information to the second external user terminal through the second BLE connection with the second external user terminal.

Based on approving image identity between the photographed image information and a first recorded image information of the first external user terminal, the controller may receive a soft Access Point (AP) information for accessing the first external user terminal as the access information from the first external user terminal through the first BLE connection and terminals the first BLE connection.

Based on disapproving image identity between the photographed image information and a second recorded image information of the second external user terminal, the controller may terminate the second BLE connection.

The user terminal may include an Extended Reality (ER) device.

In another aspect, as embodied and broadly described herein, a method of controlling a user terminal according to the present disclosure may include photographing a screen currently displayed by a first external user terminal among a plurality of external user terminals through a camera, transmitting photographed image information to a management server or the first external user terminal, and automatically accessing the first external user terminal based on access information received from the management server or the first external user terminal.

Accordingly, effects of a user terminal and method of controlling the same according to the present disclosure will be described as follows.

According to at least one of the various aspects of the present disclosure, there is an advantage in that it is possible to provide a simple and secure communication connection system between user terminals.

Effects obtainable from the present disclosure may be non-limited by the above-mentioned effects. And, other unmentioned effects can be clearly understood from the following description by those having ordinary skill in the technical field to which the present disclosure pertains.

### BRIEF DESCRIPTION OF THE DRAWINGS

The present disclosure will become more fully understood from the detailed description given herein below and the accompanying drawings, which are given by illustration only, and thus are not limitative of the present disclosure.

FIG. 1 is a block diagram for describing a user terminal related to the present disclosure.

FIG. 2 is a block diagram for describing an XR device related to the present disclosure.

FIG. 3 is a diagram illustrating an example of a communication connection between an XR device and another user terminal according to one aspect of the present disclosure.

FIGS. 4 to 8 are flowcharts of connecting communication between a user terminal and another user terminal according to one aspect of the present disclosure.

FIG. 9 is a diagram illustrating an example of a user terminal that outputs a feature pattern on a screen according to one aspect of the present disclosure.

FIG. 10 and FIG. 11 are flowcharts of connecting communication between a user terminal and another user terminal according to one aspect of the present disclosure.

### DETAILED DESCRIPTION OF THE DISCLOSURE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Each of these components may be configured as a separate individual hardware module or implemented as two or more hardware modules. Two or more components may be implemented as a single hardware module. In some cases, at least one of these components may be implemented as software.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

In this disclosure, the expression “at least one of A or B” may mean “A”, “B”, or “A and B”.

User terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like. [symbol] [symbol] [symbol] [symbol] .

By way of non-limiting example only, further description will be made with reference to particular types of user terminals. However, such teachings apply equally to other types of terminals, such as those types noted above. In addition, these teachings may also be applied to stationary terminals such as digital TV, desktop computers, digital signages, and the like.

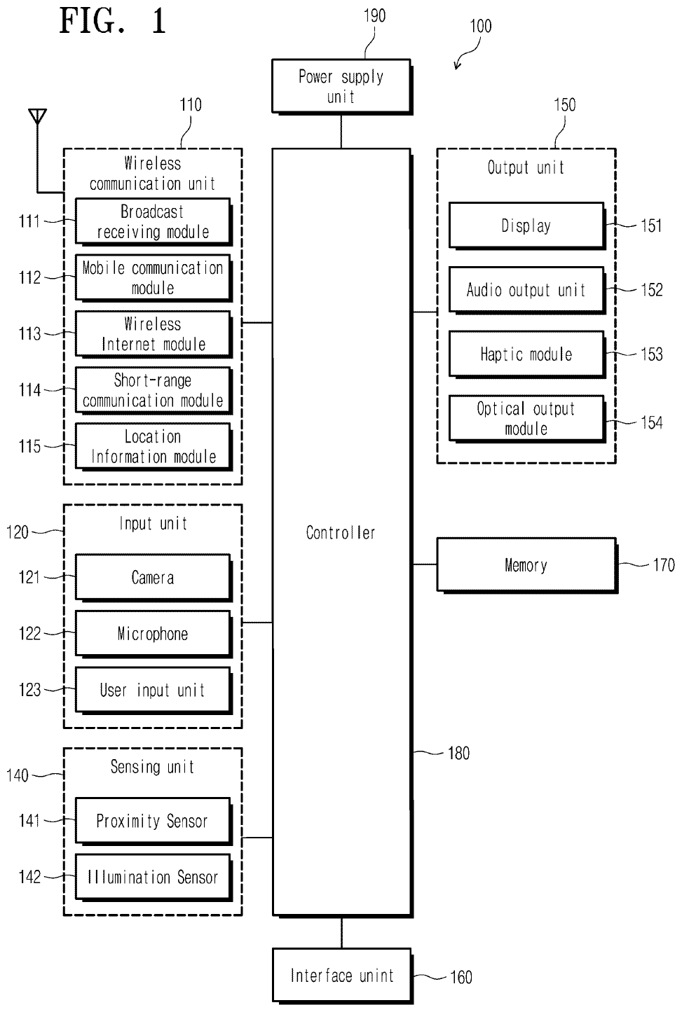

Reference is now made to FIG. 1, which is a block diagram of a user terminal in accordance with the present disclosure.

The user terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the user terminal 100 is shown having wireless communication unit 110 configured with several commonly implemented components. For instance, the wireless communication unit 110 typically includes one or more components which permit wireless communication between the user terminal 100 and a wireless communication system or network within which the user terminal is located.

The wireless communication unit 110 typically includes one or more modules which permit communications such as wireless communications between the user terminal 100 and a wireless communication system, communications between the user terminal 100 and another user terminal, communications between the user terminal 100 and an external server. Further, the wireless communication unit 110 typically includes one or more modules which connect the user terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the user terminal, the surrounding environment of the user terminal, user information, and the like. For example, in FIG. 1, the sensing unit 140 is shown having a proximity sensor 141 and an illumination sensor 142. [0086] If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The user terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the user terminal 100 and a user, as well as function as the user input unit 123 which provides an input interface between the user terminal 100 and the user.

The interface unit 160 serves as an interface with various types of external devices that can be coupled to the user terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the user terminal 100 may perform assorted control functions associated with a connected external device, in response to the external device being connected to the interface unit 160.

The memory 170 is typically implemented to store data to support various functions or features of the user terminal 100. For instance, the memory 170 may be configured to store application programs executed in the user terminal 100, data or instructions for operations of the user terminal 100, and the like. Some of these application programs may be downloaded from an external server via wireless communication. Other application programs may be installed within the user terminal 100 at time of manufacturing or shipping, which is typically the case for basic functions of the user terminal 100 (for example, receiving a call, placing a call, receiving a message, sending a message, and the like). It is common for application programs to be stored in the memory 170, installed in the user terminal 100, and executed by the controller 180 to perform an operation (or function) for the user terminal 100.

The controller 180 typically functions to control overall operation of the user terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170.

As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the user terminal 100. The power supply unit 190 may include a battery, and the battery may be configured to be embedded in the terminal body, or configured to be detachable from the terminal body.

At least some of the components may operate in cooperation with each other to implement an operation, control, or a control method of the user terminal according to various embodiments to be described below. In addition, the operation, the control, or the control method of the user terminal may be implemented on the user terminal by driving at least one application program stored in the memory 170.

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the user terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external user terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), 5G, and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the user terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), 5G and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A, 5G and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the user terminal 100 and a wireless communication system, communications between the user terminal 100 and another user terminal 100, or communications between the user terminal and a network where another user terminal 100 (or an external server) is located, via wireless area networks. One example of the wireless area networks is a wireless personal area networks.

In some embodiments, another user terminal (which may be configured similarly to user terminal 100) may be a wearable device, for example, a smart watch, a smart glass or a head mounted display (HMD), which is able to exchange data with the user terminal 100 (or otherwise cooperate with the user terminal 100). The short-range communication module 114 may sense or recognize the wearable device, and permit communication between the wearable device and the user terminal 100. In addition, when the sensed wearable device is a device which is authenticated to communicate with the user terminal 100, the controller 180, for example, may cause transmission of data processed in the user terminal 100 to the wearable device via the short-range communication module 114. Hence, a user of the wearable device may use the data processed in the user terminal 100 on the wearable device. For example, when a call is received in the user terminal 100, the user may answer the call using the wearable device. Also, when a message is received in the user terminal 100, the user can check the received message using the wearable device.

The location information module 115 is generally configured to detect, calculate, derive or otherwise identify a position of the user terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the user terminal. As one example, when the user terminal uses a GPS module, a position of the user terminal may be acquired using a signal sent from a GPS satellite. As another example, when the user terminal uses the Wi-Fi module, a position of the user terminal can be acquired based on information related to a wireless access point (AP) which transmits or receives a wireless signal to or from the Wi-Fi module.

The input unit 120 may be configured to permit various types of input to the user terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the user terminal 100. As another example, the cameras 121 may be located in a stereoscopic arrangement to acquire left and right images for implementing a stereoscopic image. The plurality of cameras 121 may include a depth camera and/or a time of flight (TOF) camera for three-dimensionally sensing a subject.

The microphone 122 is generally implemented to permit audio input to the user terminal 100. The audio input can be processed in various manners according to a function being executed in the user terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the user terminal 100. The user input unit 123 may include one or more of a mechanical input element (for example, a key, a button located on a front and/or rear surface or a side surface of the user terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the user terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the user terminal, surrounding environment information of the user terminal, user information, or the like. The controller 180 generally cooperates with the sending unit 140 to control operation of the user terminal 100 or execute data processing, a function or an operation associated with an application program installed in the user terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the user terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the user terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the user terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the user terminal 100. For example, the display unit 151 may display execution screen information of an application program executing at the user terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the user terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the user terminal 100.

An optical output module 154 can output a signal for indicating an event generation using light of a light source. Examples of events generated in the user terminal 100 may include message reception, call signal reception, a missed call, an alarm, a schedule notice, an email reception, information reception through an application, and the like.

A signal output by the optical output module 154 may be implemented in such a manner that the user terminal emits monochromatic light or light with a plurality of colors. The signal output may be terminated as the user terminal senses that a user has checked the generated event, for example.

The interface unit 160 serves as an interface for external devices to be connected with the user terminal 100. For example, the interface unit 160 can receive data transmitted from an external device, receive power to transfer to elements and components within the user terminal 100, or transmit internal data of the user terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, HDMI (High Definition Multimedia Interface) ports, USB (Universal Serial Bus) ports, ThunderBolt ports, DisplayPort or the like. When the user terminal 100 is connected to the external device through the wireless communication unit 110, the wireless communication unit 110 may be understood as a sort of the interface unit 160.

The identification module may be a chip that stores various information for authenticating authority of using the user terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the user terminal 100 is connected with an external cradle, the interface unit 160 can serve as a passage to allow power from the cradle to be supplied to the user terminal 100 or may serve as a passage to allow various command signals input by the user from the cradle to be transferred to the user terminal there through. Various command signals or power input from the cradle may operate as signals for recognizing that the user terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The user terminal 100 may also be operated in relation to a network storage device that performs the storage function of the memory 170 over a network, such as the Internet.

The controller 180 may typically control the general operations of the user terminal 100. For example, the controller 180 may set or release a lock state for restricting a user from inputting a control command with respect to applications when a status of the user terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the user terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

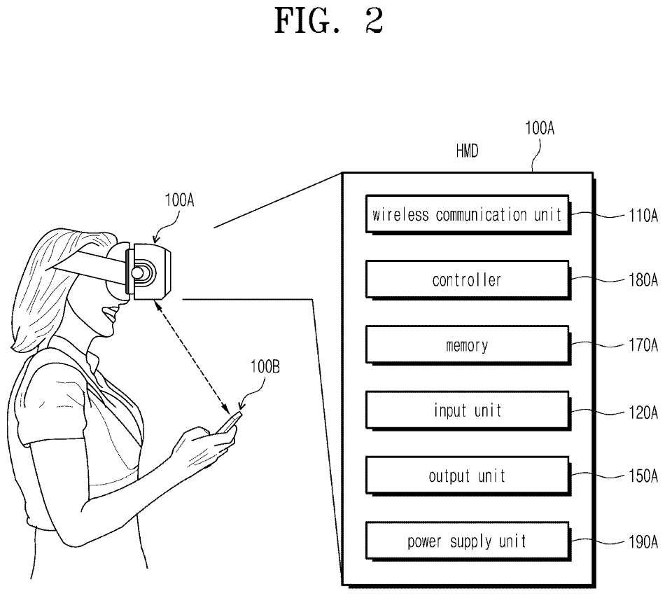

Referring to FIG. 2, an XR device related to the present disclosure will be described. FIG. 2 is a block diagram for describing an XR device related to the present disclosure. An XR device may be understood as a kind of user terminal of FIG. 1. A reference number of the XR device of FIG. 2 will be denoted as 100A, and a reference number of a user terminal of FIG. 1 will be denoted as 100B. In order to distinguish a component of the XR device of FIG. 2 from a component of another user terminal, “A” will be written in the reference number 1 of each component of the XR device.

An XR device 100A may include more components than those illustrated in FIG. 2. For example, the XR device 100A may further include some of the components of the user terminal 100b of FIG. 1.

The XR device 100A of FIG. 2 is illustrated as being implemented as a Head-Mount display (HMD) type, but it is a matter of course that it may be configured as an XR glass or goggle type.

The XR device 100A may include a wireless communication unit 110A, a controller 180A, a memory 130A, an input unit 120A, an output unit 150A, and a power supply unit 190A.

Each component of the XR device 100A may be related to the corresponding component described in the user terminal 100b of FIG. 1. A detailed description of each component of the XR device 100A will be omitted.

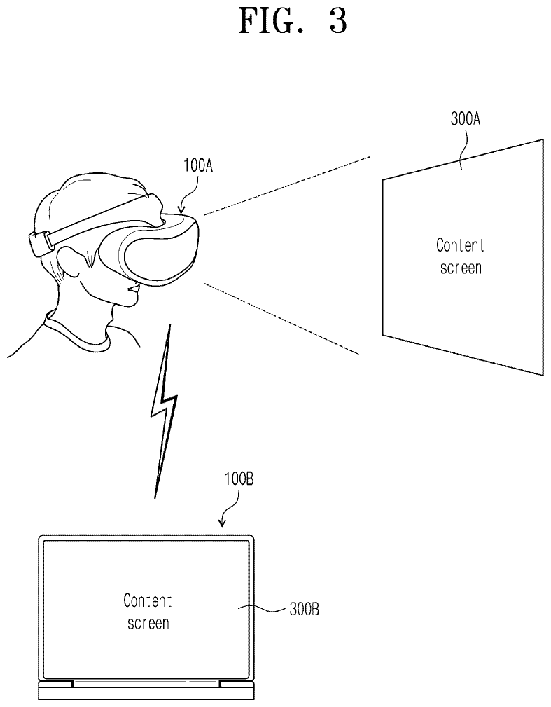

Hereinafter, a communication connection between the XR device 100A and another user terminal 100B will be described with reference to FIG. 3. FIG. 3 illustrates an example of a communication connection between an XR device and another user terminal according to one aspect of the present disclosure.

As shown in FIG. 3, the wireless communication unit 110A of the XR device 100A and the wireless communication unit 110 of the user terminal 100B may be connected to each other through wireless communication. The XR device 100A and the user terminal 100B may be connected to each other through wireless communication, for example, an Internet communication system or a Wi-Fi communication system, but are not limited thereto.

The XR device 100A and the user terminal 100B may share multimedia content with each other through a wireless communication connection therebetween.

For example, the XR device 100A may share multimedia content that the user terminal 100B plays. Alternatively, the user terminal 100B may share multimedia content that the user terminal 100B plays with the XR device 100A.

Accordingly, a content screen 300A displayed by the XR device 100A and a content screen 300B displayed by the user terminal 100B may be mirrored screens.

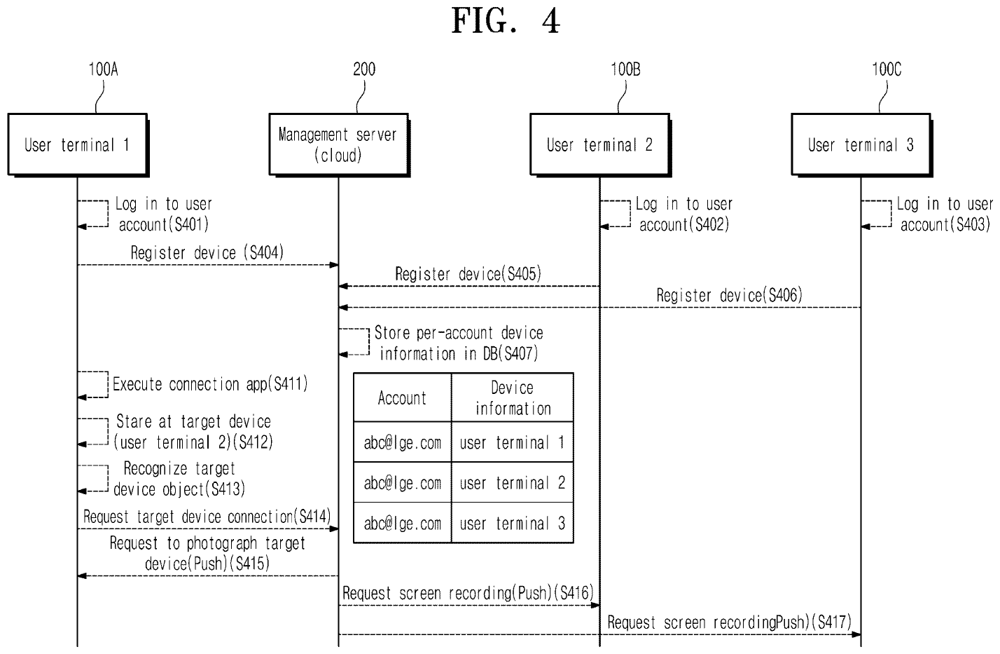

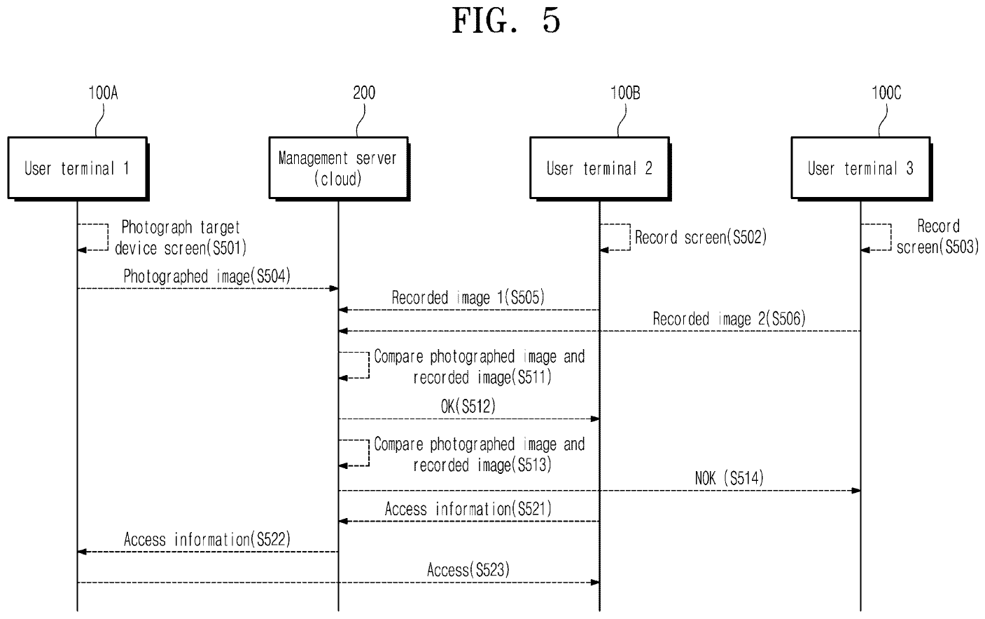

Hereinafter, a process in which the XR device 100A connects communication with a user terminal desired by a user among a plurality of other user terminals will be described with reference to FIG. 4 and FIG. 5. FIG. 4 and FIG. 5 are flowcharts in which a user terminal connects communication with another user terminal according to one aspect of the present disclosure.

Hereinafter, it will be assumed that a first user terminal 100A is the XR device 100A. However, other types of user terminals (e.g., smartphones, tablet PCs, etc.) other than the XR device 100A may also be used as the first user terminal 100A. “First” will be written in the name of each component of the first user terminal 100A, and “A” will be written in a reference number of each component of the first user terminal 100A.

Hereinafter, it is assumed that a second user terminal 100B and a third user terminal 100C are present as a plurality of other user terminals. Yet, in addition to the second user terminal 100B and the third user terminal 100C, at least one or more other user terminals may be present as a plurality of other user terminals. Each of the second user terminal 100B and the third user terminal 100C may be, for example, any one of a smartphone, a tablet PC, and a notebook computer. “Second” will be written in the name of each component of the second user terminal 100B and “third” will be written in the name of each component of the third user terminal 100C. Then, “B” will be written in a reference number of each component of the second user terminal 100B, and “C” will be written in a reference number of each component of the third user terminal 100C.

In FIG. 4 and FIG. 5, it is assumed that each of the first user terminal 100A, the second user terminal 100B, and the third user terminal 100C is in an Internet-accessible state.

First, each of the first user terminal 100A, the second user terminal 100B, and the third user terminal 100C may log in to a management server 200 with the same user account [S401, S402, S403). The management server 200 may be, for example, a cloud server. That is, the first user terminal 100A, the second user terminal 100B, and the third user terminal 100C may be managed as one group using a user account. If it is possible to manage a plurality of user terminals as one group, it is all right to use a plurality of user accounts.

It is not necessary that there is a temporal order among the steps S401, S402, and S403. It is all right that one step may be executed before the other steps. These steps may be executed simultaneously.

Each of the first user terminal 100A, the second user terminal 100B, and the third user terminal 100C may perform its device registration on the management server 200 by transmitting device information (e.g., a device identifier such as a Media Access Control (MAC) address) of its own to the management server 200 [S404, S405, S406]. It is not necessary that there is a temporal order among the steps S404, S405, and S406. It is all right that one step may be executed before the other steps. These steps may be executed simultaneously.

The management server 200 may store device information registered for each user account [S407]. Accordingly, the management server 200 may know which devices (i.e., first user terminal 100A, second user terminal 100B, and third user terminal 100C) are registered for the same user account.

The first user terminal 100A (or a first controller 180A of the first user terminal 100A) may execute a connection application for connection with another user terminal [S411]. The connection application of the first user terminal 100A may be executed in response to a user command inputted through a first input unit 120A, or may be automatically executed in response to occurrence of a prescribed event (for example, Internet access). If the connection application has already been executed in a foreground or background in the first user terminal 100A, the step S411 may be omitted.

A user of the first user terminal 100A may desire to connect one (hereinafter, a target device) of the second user terminal 100B and the third user terminal 100C to the first user terminal 100A in wireless communication. Hereinafter, it is assumed that the target device is the second user terminal 100B.

In this case, the user may trigger a wireless communication connection between the first user terminal 100A and the second user terminal 100B by wearing the first user terminal 100A, i.e., an XR device and staring at the second user terminal 100B as a target device [S412]. When the wireless communication connection between the first user terminal 100A and the second user terminal 100B is triggered, the first user terminal 100A may display an alarm graphic (and/or text) indicating that the wireless communication connection has been triggered. The alarm graphic may be displayed until at least a step S501 to be described later is completed.

Here, when the user wears the XR device 100A and stares at the second user terminal 100B, it may mean that a camera of the XR device 100A is activated and the second user terminal 100B may exist within an angle of view of the camera. Therefore, when the first user terminal 100A is a device of a different type (e.g., a smartphone or a tablet PC) other than the XR device 100A, the step S412 may be performed by activating a camera of a different type of device and directing the camera toward the target device to allow the target device to be in the angle of view of the camera. A wireless communication connection between the first user terminal 100A and the second user terminal 100B may be triggered when the target device is maintained within the angle of view of the activated camera for a prescribed time (e.g., one second or two seconds).

When the wireless communication connection is triggered, the first user terminal 100A may recognize an external appearance of the second user terminal 100B which is the target device, and the second user terminal 100B may recognize that the first user terminal 100A is a type of wireless communication connectible device [S413]. Information on the type of the wireless communication connectible device with the first user terminal 100A may be previously stored in a first memory 170A of the first user terminal 100A.

When the second user terminal 100B is recognized as the type of the wireless communication connectible device, the first user terminal 100A may make a request for a wireless communication connection with the target device to the management server 200 [S414].

Then, the management server 200 may transmit a photographing request signal (or message) to the first user terminal 100A to request the first user terminal 100A to photograph (or capture) the second user terminal 100B (i.e., a display screen displayed by the second user terminal 100B), which is the target device, for a reference time (or by the number of reference frames) [S415].

In addition, the management server 200 may transmit a recording request signal (or message) to each of the other user terminals managed as the same group as the first user terminal 100A (i.e., the second user terminal 100B and the third user terminal 100C) to photograph (or capture) a screen currently being displayed by the other user terminal for a reference time (or by the number of reference frames) [S416, S417].

A time when the management server 200 transmits the photographing request signal to the first user terminal 100A and a time when the management server 200 transmits the recording request signal to the other user terminals 100B and 100C may be substantially the same or within a prescribed margin time.

Referring to FIG. 5, the first user terminal 100A may photograph a display screen currently displayed on the second user terminal 100B for a reference time (or by the number of reference frames) in response to the photographing request signal received from the management server 200 while staring at the second user terminal 100B [S501].

The second user terminal 100B (or a second controller 180B of the second user terminal 100B) may record or capture the screen currently being displayed by the second user terminal 100B for the reference time (or by the number of reference frames) in response to the recording request signal received from the management server 200 [S502].

The third user terminal 100C (or a third controller 180C of the third user terminal 100C) may record or capture a screen currently being displayed by the third user terminal 100C for a reference time (or by the number of reference frames) in response to the recording request signal received from the management server 200 [S503].

Since the transmission time of the photographing request signal and the transmission time of the recording request signal are substantially the same or within a prescribed margin time, as described above, the steps S501, S502, and S503 may be simultaneously performed substantially (or within a prescribed margin time).

The first user terminal 100A may transmit a photographed video (or a photographed image frame corresponding to the number of reference frames) photographed by the first user terminal 100A to the management server 200 [S504] To reduce the weight of transmission, the first user terminal 100A may transmit a photographed image hash value of the photographed image frame to the management server 200 instead of the photographed image frame.

The second user terminal 100B may transmit a first recorded video (or a first captured image frame corresponding to the number of reference frames) that the second user terminal 100B has recorded to the management server 200 [S505]. The second user terminal 100B may transmit a first image hash value of a first captured image frame to the management server 200 instead of a first captured image in order to reduce the weight of transmission.

The third user terminal 100C may transmit a second recorded video (or a second captured image frame amounting to the number of reference frames) recorded by the third user terminal 100C to the management server 200 [S506]. In order to reduce the weight of transmission, the third user terminal 100C may transmit a second image hash value of the second captured image frame to the management server 200 instead of the second captured image frame.

It is not necessary that there is a temporal order among the steps S504, S505, and S506. It is all right that one step may be executed before the other steps. These steps may be executed simultaneously.

The management server 200 may compare the photographed video received from the first user terminal 100A with the first recorded video received from the second user terminal 100B to determine whether there is image identity between the photographed video and the second recorded video [S511]. Alternatively, the management server 200 may compare the photographed image frame received from the first user terminal 100A with the first captured image frame received from the second user terminal 100B to determine whether there is image identity between the photographed image frame and the first captured image frame. Alternatively, the management server 200 may compare the photographed image hash value received from the first user terminal 100A with the first image hash value received from the second user terminal 100B to determine whether there is image identity between the photographed image hash value and the first image hash value.

Since the first user terminal 100A has photographed or captured the display screen currently being displayed by the second user terminal 100B, there is a very high possibility that the image information received from the first user terminal 100A and the image information received from the second user terminal 100B have image identity. It is assumed that there is the image identity between them, and the description will be continued.

The existence of the image identity between them may mean that the second user terminal 100B is specified as the target device. When it is recognized that the image identity exists, the management server 200 may transmit an image identity approval signal to the second user terminal 100B [S512].

Meanwhile, the management server 200 may compare the photographed video received from the first user terminal 100A with the second recorded video received from the third user terminal 100C to determine whether there is image identity between the photographed video and the second recorded video [S513]. Alternatively, the management server 200 may compare the photographed image frame received from the first user terminal 100A with the second captured image frame received from the third user terminal 100C to determine whether there is image identity between the photographed image frame and the second captured image frame. Alternatively, the management server 200 may compare the photographed image hash value received from the first user terminal 100A with the second image hash value received from the third user terminal 100C to determine whether there is image identity between the photographed image hash value and the second image hash value.

Since the first user terminal 100A has photographed or captured the display screen currently being displayed by the second user terminal 100B, the possibility of the existence of the image identity between image information received from the first user terminal 100A and the image information received from the third user terminal 100C is quite low. It is assumed that there is no image identity between them, and the description will be continued.

If it is not recognized that there is the image identity between them, the management server 200 may transmit an image identity disapproval signal to the third user terminal 100C [S514].

It is not necessary to have a temporal order between the steps S511 and S512 and the steps S513 and S514. The steps S511 and S512 may be executed behind the steps S513 and S514. Alternatively, the steps S511 and S512 may be executed substantially simultaneously with the steps S513 and S514.

In response to receiving the image identity approval signal, the second user terminal 100B may transmit its access information (e.g., Internet Protocol (IP) address and port number) to the management server 200 [S521].

The management server 200 may transmit the access information of the second user terminal 100B to the first user terminal 100A again [S522].

The first user terminal 100A may automatically access the second user terminal 100B, which is the target device, by using the access information of the second user terminal 100B [S523].

That is, a wireless communication connection between the first user terminal 100A and the second user terminal 100B may be performed simply if a user wearing the XR device 100A, which is the first user terminal 100A, just stares at the second user terminal 100B that is the target device.

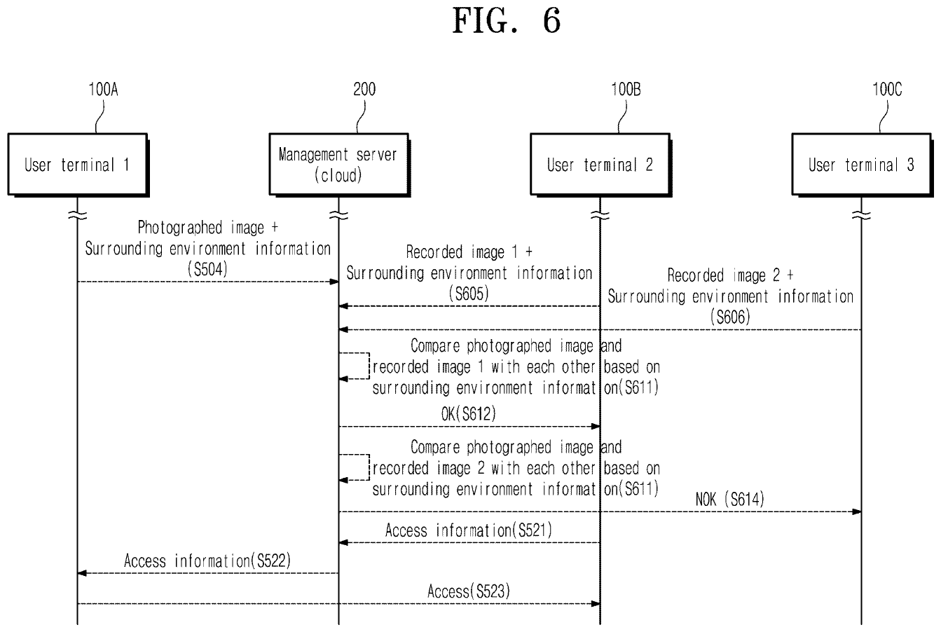

In FIG. 4 and FIG. 5, specifying a target device based on image information received from each user terminal has been described. However, in order to more accurately specify a target device, surrounding environment information of each user terminal may be further considered in addition to image information received from each user terminal. This will be described further with reference to FIG. 6. FIG. 6 is a flowchart in which a user terminal performs communication connection with another user terminal according to one aspect of the present disclosure.

Since the steps S401 to S417 of FIG. 4 and the steps S501 to S503 of FIG. 5 are performed in the same manner in FIG. 6, a description thereof will be omitted for simplicity and clarity of the present disclosure.

The first user terminal 100A may transmit a photographed video (or a photographed image frame amounting to the number of reference frames) photographed by the first user terminal 100A and surrounding environment information thereof to the management server 200 [S604] In order to reduce the weight of transmission, the first user terminal 100A may transmit the photographed image hash value of the photographed image frame to the management server 200 instead of the photographed image frame. The surrounding environment information may include location information, such as GPS, of the first user terminal 100A and/or a list of peripheral wireless Wi-Fi Access Points (APs) searchable by the first user terminal 100A (e.g., a list of Service Set Identifiers (SSIDs) of searchable peripheral Wi-Fi APs), and the like.

The second user terminal 100B may transmit a first recorded video (or a first captured image frame amounting to the number of reference frames), which the second user terminal 100B has recorded, and surrounding environment information to the management server 200 [S605]. The second user terminal 100B may transmit the first image hash value of the first captured image frame to the management server 200 in place of the first captured image in order to reduce the weight of transmission. The surrounding environment information may include location information, such as GPS, of the second user terminal 100B and/or a list of peripheral wireless Wi-Fi Access Points (APs) searchable by the second user terminal 100B (e.g., a list of Service Set Identifiers (SSIDs) of searchable peripheral Wi-Fi APs), and the like.

The third user terminal 100C may transmit a second recorded video (or a second captured image frame corresponding to the number of reference frames) recorded by the third user terminal 100C and surrounding environment information to the management server 200 [S606]. The third user terminal 100C may transmit the second image hash value of the second captured image frame to the management server 200 in place of the second captured image frame in order to reduce the weight of transmission. The surrounding environment information may include location information, such as GPS, of the third user terminal 100C and/or a list of peripheral wireless Wi-Fi Access Points searchable by the third user terminal 100C (e.g., a list of Service Set Identifiers (SSIDs) of searchable peripheral Wi-Fi APs), and the like.

It is not necessary that there is a temporal order among the steps S604, S605, and S606. It is all right that one step may be executed before the other steps. These steps may be executed simultaneously.

The management server 200 may compare the photographed video received from the first user terminal 100A with the first recorded video received from the second user terminal 100B to determine whether there is image identity between the photographed video and the second recorded video [S611]. Alternatively, the management server 200 may compare the photographed image frame received from the first user terminal 100A with the first captured image frame received from the second user terminal 100B to determine whether there is image identity between the photographed image frame and the first captured image frame. Alternatively, the management server 200 may compare the photographed image hash value received from the first user terminal 100A with the first image hash value received from the second user terminal 100B to determine whether there is image identity between the photographed image hash value and the first image hash value.

The management server 200 may further consider the surrounding environment information received from each of the first user terminal 100A and the second user terminal 100B in determining the image identity between the photographed video and the first recorded video [S611]. For example, the management server 200 may further consider the surrounding environment information received from each of the first user terminal 100A and the second user terminal 100B, and may then approve that the image identity between the photographed video and the first recorded video is present when surrounding environment identity between them is equal to or higher than a prescribed level.

The fact that the surrounding environment identity is equal to or higher than the prescribed level may mean that the location information of the first user terminal 100A and the location information between the second user terminal 100B are close within a prescribed distance. Alternatively, the fact that the surrounding environment identity is equal to or higher than the prescribed level may mean that the same items between the list of the wireless Wi-Fi APs searchable by the first user terminal 100A and the list of the wireless Wi-Fi APs searchable by the second user terminal 100B are equal to or more than a prescribed number or a prescribed rate.

Since the first user terminal 100A photographs or captures the display screen currently displayed by the second user terminal 100B, it is highly probable that there is not only the surrounding environment identity between the surrounding environment informations received from the first user terminal 100A and the second user terminal 100B, respectively, but also the image identity between the image information received from the first user terminal 100A and the image information received from the second user terminal 100B. The description will be continued on the assumption that there are the surrounding environment identity and the image identity between them.

The existence of the surrounding environment identity and the image identity therebetween may mean that the second user terminal 100B is specified as the target device. When it is approved that the surrounding environment identity and the image identity are present, the management server 200 may transmit an image identity approval signal to the second user terminal 100B [S612].

Meanwhile, the management server 200 may compare the photographed video received from the first user terminal 100A with the second recorded video received from the third user terminal 100C to determine whether there is image identity between the photographed video and the second recorded video [S613]. Alternatively, the management server 200 may compare the photographed image frame received from the first user terminal 100A with the second captured image frame received from the third user terminal 100C to determine whether there is image identity between the photographed image frame and the second captured image frame. Alternatively, the management server 200 may compare the photographed image hash value received from the first user terminal 100A with the second image hash value received from the third user terminal 100C to determine whether there is image identity between the photographed image hash value and the second image hash value.

The management server 200 may further consider the surrounding environment information received from each of the first user terminal 100A and the third user terminal 100C in determining the image identity between the photographed video and the second recorded video [S613]. For example, the management server 200 may further consider the surrounding environment information received from each of the first user terminal 100A and the third user terminal 100C, and may then approve that the image identity between the photographed video and the second recorded video is present when the surrounding environment identity between them is higher than or equal to a prescribed level.

The fact that the surrounding environment identity is equal to or higher than the prescribed level may mean that the location information of the first user terminal 100A and the location information between the third user terminal 100C are close within a prescribed distance. Alternatively, the fact that the surrounding environment identity is equal to or higher than the prescribed level may mean that the same items between the list of wireless Wi-Fi APs searchable by the first user terminal 100A and the list of wireless Wi-Fi APs searchable by the third user terminal 100C are equal to or more than a prescribed number or a prescribed rate.

Since the first user terminal 100A photographs or captures the display screen currently displayed by the second user terminal 100B, it is quite unlikely that there is an image identity between the image information received from the first user terminal 100A and the image information received from the third user terminal 100C.

Even if the image identity between the image information received from the first user terminal 100A and the image information received from the third user terminal 100C is accidently present, the possibility of the presence of the surrounding environment identity between the surrounding environment informations respectively received from the first user terminal 100A and the third user terminal 100C is low. Accordingly, when it is approved that there is no image identity, or that there is no surrounding environment identity despite the accidental presence of the image identity, the management server 200 may transmit an image identity disapproval signal to the third user terminal 100C [S614].

It is not necessary to have a temporal order between the steps S611 and S612 and the steps S613 and S614. The steps S611 and S612 may be executed later than the steps S613 and S614. Alternatively, the steps S611 and S612 may be executed substantially simultaneously with the steps S613 and S614.

The second user terminal 100B may transmit its access information (e.g., Internet Protocol (IP) address and port number) to the management server 200 in response to receiving the image identity approval signal [S521].

The management server 200 may transmit the access information of the second user terminal 100B to the first user terminal 100A again [S522].

The first user terminal 100A may automatically access the second user terminal 100B, which is a target device, by using the access information of the second user terminal 100B [S523].

That is, if a user simply wears the XR device 100A which is the first user terminal 100A and stares at the second user terminal 100B which is the target device, a wireless communication connection may be made between the first user terminal 100A and the second user terminal 100B.

With reference to FIG. 6, described is that a target device is specified based on image information and surrounding environment information received from each user terminal. By the way, the second user terminal 100B and the third user terminal 100C may be displaying the same or similar image or screen by accident, and the second user terminal 100B and the third user terminal 100C may be positioned close to each other. In this case, it may be difficult to specify a target device.

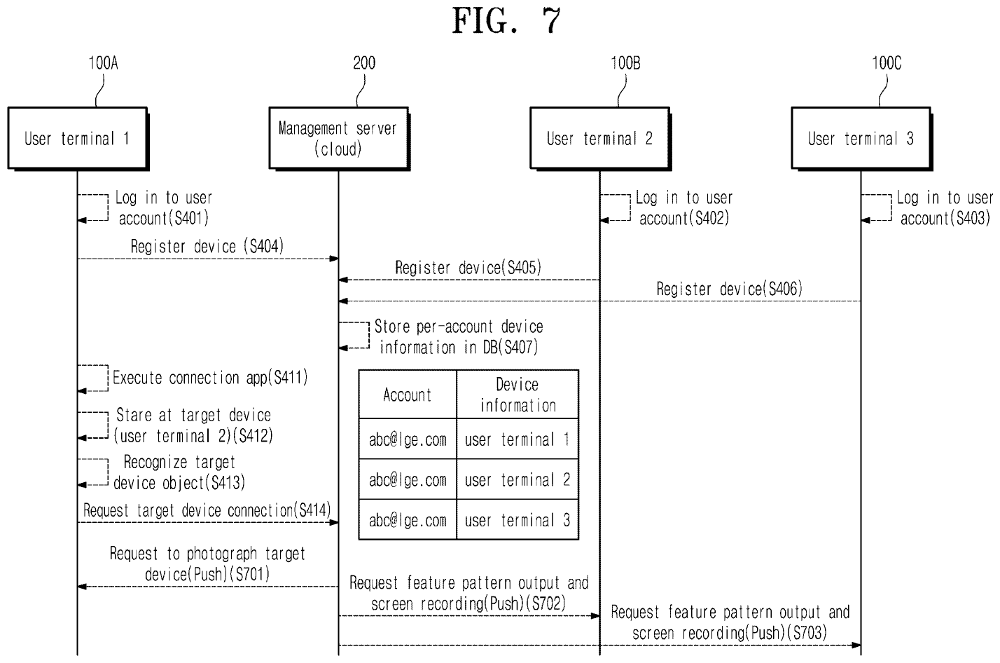

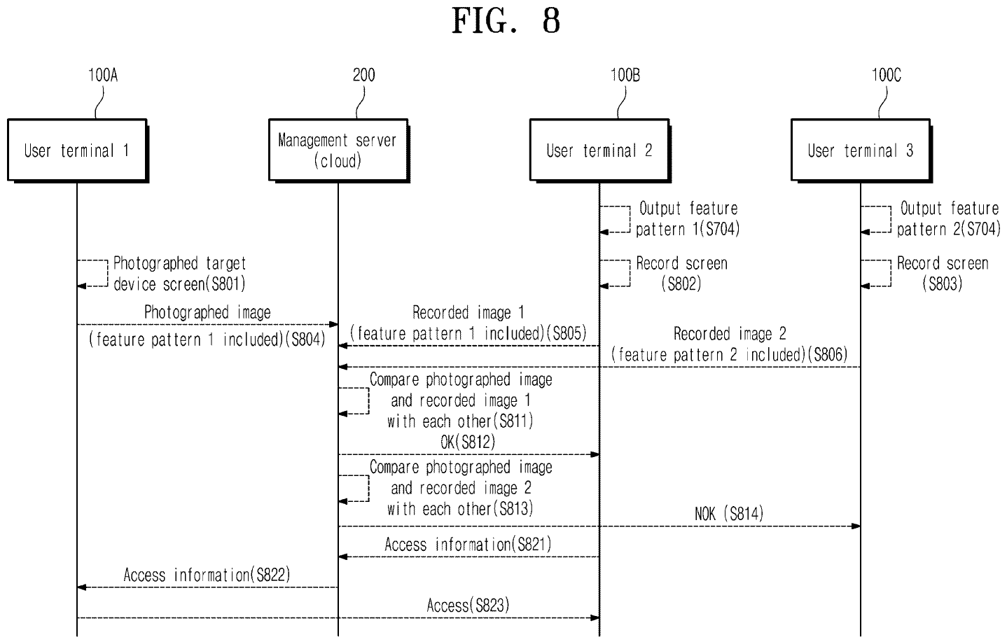

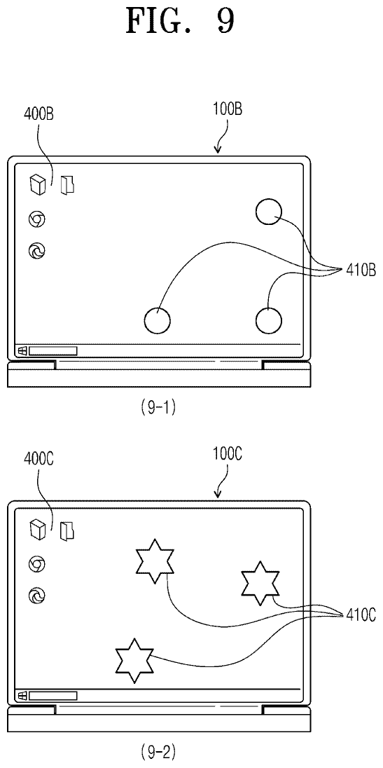

Accordingly, in order to more accurately specify a target device, each of the second user terminal 100B and the third user terminal 100C outputs a feature pattern on a screen, and a target device may be specified by receiving image information including the feature pattern from each of the user terminals. This will be described further with reference to FIGS. 7 to 9. FIG. 7 and FIG. 8 are flowcharts in which one user terminal connects communication with another user terminal according to one aspect of the present disclosure. FIG. 9 illustrates an example of a user terminal outputting a feature pattern on a screen according to one aspect of the present disclosure.

First, referring to FIG. 7, the steps S401 to S414 of FIG. 7 are the same as those described in FIG. 4, and thus a detailed description thereof will be omitted for simplicity of the present disclosure.

In response to a wireless communication connection request from the first user terminal 100A, the management server 200 may transmit, to the first user terminal 100A, a photographing request signal (or message) requesting that the first user terminal 100A should photograph (or capture) the second user terminal 100B (i.e., a display screen displayed on the second user terminal 100B), which is a target device, for a reference time (or by the number of reference frames) [S701].

In addition, the management server 200 may transmit a feature pattern output and recording request signal (or message) requesting that each of the other user terminals managed as the same group as the first user terminal 100A (i.e., the second user terminal 100B and the third user terminal 100C) should output a specific pattern on a currently displayed screen thereof and record (or capture) an outputted screen of the currently displayed feature pattern for a reference time (or by the number of reference frames) [S702, S703].

The time when the management server 200 transmits the feature pattern output and recording request signal to the first user terminal 100A and the time when the management server 200 transmits the feature pattern output and recording request signal to the other user terminals 100B and 100C may be substantially the same or within a predetermined margin time.

Referring to FIG. 8, the second user terminal 100B may output a first feature pattern to the screen currently being displayed by itself for the reference time [S704]. The first feature pattern may be outputted instead of the screen currently being displayed by the second user terminal 100B.

Furthermore, the third user terminal 100C may output a second feature pattern to the screen currently being displayed by itself for the reference time [S705]. The second feature pattern may be outputted instead of the screen currently being displayed by the third user terminal 100C.

The first feature pattern and the second feature pattern will be described further with reference to FIG. 9.

As shown in FIG. 9 (9-1), the second user terminal 100B may output a first feature pattern 410B for a reference time on a first screen 400B currently being displayed by the second user terminal 100B in response to a feature pattern output and recording request signal. The first feature pattern 410B may be outputted for the reference time instead of a first screen 400B. The first feature pattern is unique to the second user terminal 100B and is different from a second feature pattern.

As shown in FIG. 9 (9-2), the third user terminal 100C may output a second feature pattern 410C for a reference time on a second screen 400C currently being displayed by the third user terminal 100C in response to a feature pattern output and recording request signal. The second feature pattern 410C may be outputted for the reference time instead of a second screen 400C. The second feature pattern is unique to the third user terminal 100C and is different from the first feature pattern.

Referring back to FIG. 8, the first user terminal 100A may photograph the outputted display screen of the first feature pattern currently displayed on the second user terminal 100B for a reference time (or by the number of reference frames) in response to the photographing request signal received from the management server 200 while staring at the second user terminal 100B [S801].

The second user terminal 100B may record or capture the outputted screen of the first feature pattern currently being displayed by the second user terminal 100B for a reference time (or by the number of reference frames) in response to the feature pattern output and recording request signal received from the management server 200 [S802].

In response to the feature pattern output and recording request signal received from the management server 200, the third user terminal 100C may record or capture the screen, on which the second feature pattern currently displayed by the third user terminal 100C is outputted, for a reference time (or by the number of reference frames) [S803].

Since the transmission time of the photographing request signal and the transmission time of the feature pattern output and recording request signal are substantially the same or within a predetermined margin time, the steps S801, S802, and S803 may be performed substantially simultaneously (or within a predetermined margin time).

The first user terminal 100A may transmit a photographed video (or a photographed image frame amounting to the number of reference frames) that the first user terminal 100A has photographed to the management server 200 [S804] To reduce the weight of transmission, the first user terminal 100A may transmit a photographed image hash value of a photographed image frame to the management server 200 instead of the photographed image frame.

The second user terminal 100B may transmit a first recorded video (or a first captured image frame amounting to the number of reference frames) that the second user terminal 100B has recorded to the management server 200 [S805]. The second user terminal 100B may transmit a first image hash value of the first captured image frame to the management server 200 instead of the first captured image in order to reduce the weight of transmission.

The third user terminal 100C may transmit a second recorded video (or a second captured image frame amounting to the number of reference frames) recorded by the third user terminal 100C to the management server 200 [S606]. In order to reduce the weight of transmission, the third user terminal 100C may transmit a second image hash value of the second captured image frame to the management server 200 instead of the second captured image frame.

It is not necessary that there is a temporal order among the steps S804, S805, and S806. It is all right that one step may be executed before the other steps. These steps may be executed simultaneously.

The management server 200 may compare the photographed video received from the first user terminal 100A with the first recorded video received from the second user terminal 100B to determine whether there is image identity between the photographed video and the second recorded video [S811]. Alternatively, the management server 200 may compare the photographed image frame received from the first user terminal 100A to the first captured image frame received from the second user terminal 100B to determine whether there is image identity between the photographed image frame and the first captured image frame. Alternatively, the management server 200 may compare the photographed image hash value received from the first user terminal 100A to the first image hash value received from the second user terminal 100B to determine whether there exists image identity between the photographed image hash value and the first image hash value.

Since the first user terminal 100A photographs or captures the display screen currently being displayed by the second user terminal 100B, it is highly probable that there is image identity between the image information received from the first user terminal 100A and the image information received from the second user terminal 100B. This is more so due to the first feature pattern and the second feature pattern. It is assumed that there is image identity between them, and the description will be continued.

The presence of the image identity between them may mean that the second user terminal 100B is specified as a target device. When it is approved that the image identity exists, the management server 200 may transmit an image identity approval signal to the second user terminal 100B [S812].

Meanwhile, the management server 200 may compare the photographed video received from the first user terminal 100A with the second recorded video received from the third user terminal 100C to determine whether there is image identity between the photographed video and the second recorded video [S813]. Alternatively, the management server 200 may compare the photographed image frame received from the first user terminal 100A with the second captured image frame received from the third user terminal 100C to determine whether there is image identity between the photographed image frame and the second captured image frame. Alternatively, the management server 200 may compare the photographed image hash value received from the first user terminal 100A with the second image hash value received from the third user terminal 100C to determine whether there is image identity between the photographed image hash value and the second image hash value.

Since the first user terminal 100A photographs or captures a display screen currently being displayed by the second user terminal 100B, the possibility of the existence of the image identity between image information received from the first user terminal 100A and image information received from the third user terminal 100C is quite low. This is more so due to the first feature pattern and the second feature pattern. It is assumed that there is no image identity between them, and the description will be continued.

If it is not approved that there is the image identity between them, the management server 200 may transmit an image identity disapproval signal to the third user terminal 100C [S814].

It is not necessary that there is a temporal order between the steps S811 and S812 and the steps S813 and S814. The steps S811 and S812 may be executed later than the steps S813 and S814. Alternatively, the steps S811 and S812 may be executed substantially simultaneously with the steps S813 and S814.

The second user terminal 100B may transmit its access information (e.g., Internet Protocol (IP) address and port number) to the management server 200 in response to receiving the image identity approval signal [S821].

The management server 200 may transmit the access information of the second user terminal 100B to the first user terminal 100A again [S822].

The first user terminal 100A may automatically access the second user terminal 100B, which is a target device, by using the access information of the second user terminal 100B [S823].

That is, a wireless communication connection between the first user terminal 100A and the second user terminal 100B may be performed if a user wearing the XR device 100A, which is the first user terminal 100A, simply stares at the second user terminal 100B that is the target device.

In FIG. 7 and FIG. 8, it is described that a feature pattern is used for specification of a target device. Of course, not only the feature pattern but also the surrounding environment information may be used for the specification of the target device.

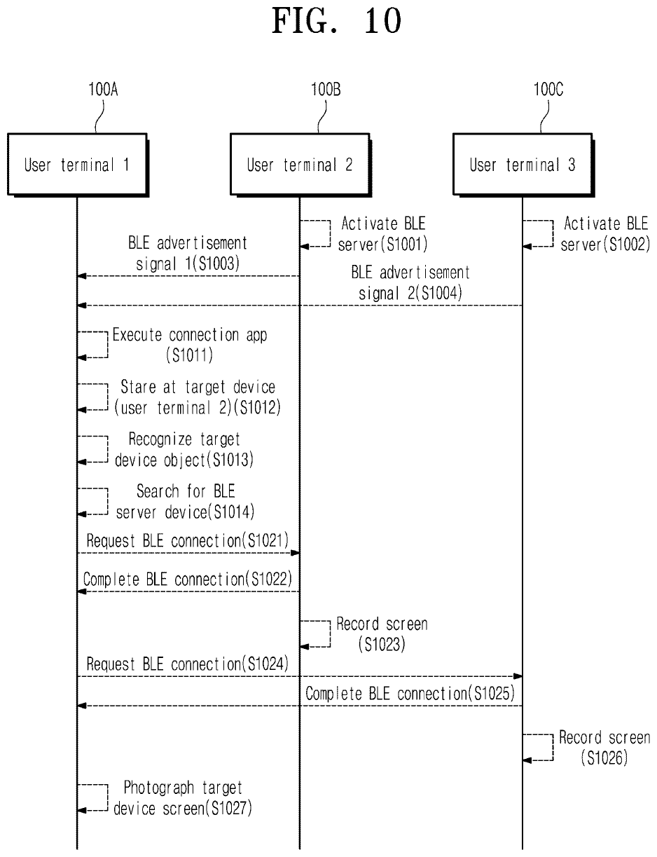

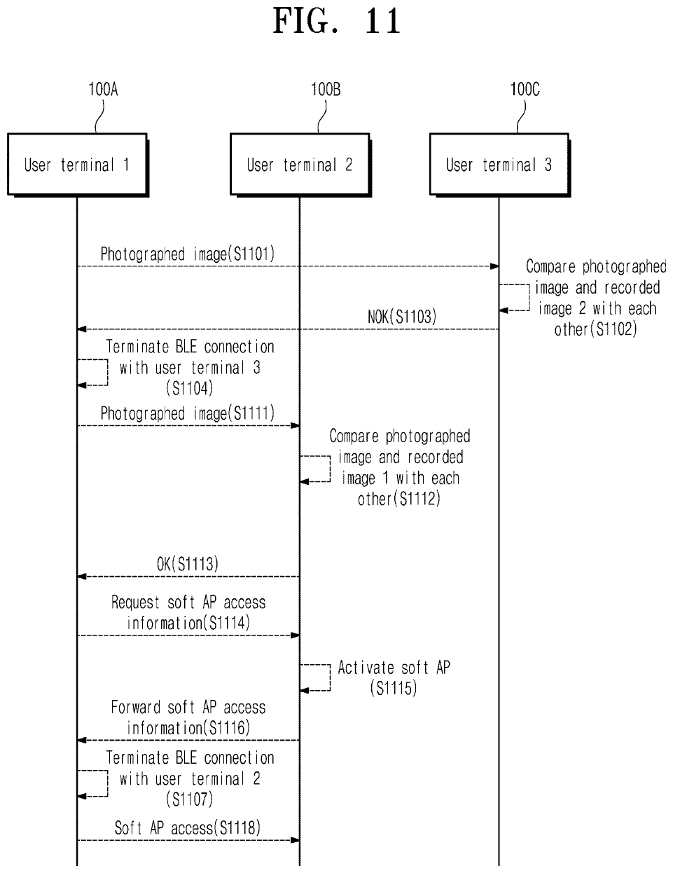

In the above description, the case where the first user terminal 100A, the second user terminal 100B, and the third user terminal 100C each operate in an Internet accessible environment has been described. Hereinafter, a case where the first user terminal 100A, the second user terminal 100B, and the third user terminal 100C operate in an Internet non-accessible environment will be described with reference to FIG. 10 and FIG. 11. FIG. 10 and FIG. 11 are flowcharts in which a user terminal connects communication with another user terminal according to one aspect of the present disclosure.

First, referring to FIG. 10, each of the second user terminal 100B and the third user terminal 100C may activate a Bluetooth Low Energy (BLE) server function [S1001, S1002]. Here, the BLE server function may include a function of transmitting an image between user terminals through Bluetooth low power communication.

The second user terminal 100B may periodically transmit a first BLE advertisement signal indicating that the Bluetooth low energy (BLE) server function of the second user terminal 100B has been activated to surroundings [S1003].

In addition, the third user terminal 100C may periodically transmit a second BLE advertisement signal indicating that the Bluetooth low energy (BLE) server function of the third user terminal 100C has been activated to surroundings [S1004].

The first user terminal 100A may execute a connection application for connection with another user terminal [S1011]. The connection application of the first user terminal 100A may be executed in response to a user command inputted through a first input unit 120A, or may be automatically executed in response to occurrence of a prescribed event (for example, Internet access). When the connection application has already been executed in the foreground or background in the first user terminal 100A, the step S1011 may be omitted.

A user of a first user terminal 100A may desire to connect one (hereinafter, a target device) of the second user terminal 100B and the third user terminal 100C to the first user terminal 100A in wireless communication. Hereinafter, it is assumed that the target device is the second user terminal 100B.

In this case, the user may trigger a wireless communication connection between the first user terminal 100A and the second user terminal 100B by wearing the first user terminal 100A, that is, the XR device and staring at the second user terminal 100B as a target device [S1012]. When the wireless communication connection between the first user terminal 100A and the second user terminal 100B is triggered, the first user terminal 100A may display an alarm graphic (and/or text) indicating that the wireless communication connection has been triggered. The alarm graphic may be displayed until at least a step S1027 to be described later is completed.

When the wireless communication connection is triggered, the first user terminal 100A may recognize an external appearance of the second user terminal 100B which is the target device and then recognize that the second user terminal 100B is a type of a wireless communication connectible device available for the first user terminal 100A [S1013]. Information on the type of the wireless communication connectible device available for the first user terminal 100A may be previously stored in a first memory 170A of the first user terminal 100A.

When the second user terminal 100B is recognized as the type of the wireless communication connectible device, the first user terminal 100A may search for BLE server devices, i.e., the second user terminal 100B and the third user terminal 100C, based on a first BLE advertisement signal and a second BLE advertisement signal [S1014].

The first user terminal 100A may transmit a first BLE connection request signal to the second user terminal 100B based on the first BLE advertisement signal [S1021].

The second user terminal 100B may transmit a first BLE connection completion signal to the first user terminal 100A in response to the first BLE connection request signal [S1022].

When the BLE connection between the first user terminal 100A and the second user terminal 100B is completed, the second user terminal 100B may record or capture a screen currently being displayed by the second user terminal 100B for a reference time (or by the number of reference frames) [S1023].

The first user terminal 100A may transmit a second BLE connection request signal to the third user terminal 100C based on the second BLE advertisement signal [S1024].

The third user terminal 100C may transmit a second BLE connection completion signal to the first user terminal 100A in response to the second BLE connection request signal [S1025].

When the BLE connection between the first user terminal 100A and the third user terminal 100C is completed, the third user terminal 100C may record or capture a screen currently being displayed by the third user terminal 100C for a reference time (or by the number of reference frames) [S1026].

When the BLE connection between the first user terminal 100A and the second user terminal 100B and the BLE connection between the first user terminal 100A and the third user terminal 100C are completed while staring at the second user terminal 100B, a display screen currently displayed by the second user terminal 100B may be photographed for a reference time (or by the number of reference frames) [S1027].

In FIG. 10, it is illustrated that the first user terminal 100A transmits a BLE connection signal to the second user terminal 100B before the third user terminal 100C, but the first user terminal 100A may transmit a BLE connection signal to the third user terminal 100C before the second user terminal 100B. Alternatively, the first user terminal 100A may actually transmit a BLE connection signal to the second user terminal 100B and the second user terminal 100C simultaneously (or simultaneously within a prescribed margin time).

Thus, the steps S1023, S1026, and S1027 may be performed substantially simultaneously (or simultaneously within a prescribed margin time).

Referring to FIG. 11, the first user terminal 100A may transmit a photographed video (or a photographed image frame amounting to the number of reference frames) photographed by the first user terminal 100B to the second user terminal 100B and/or the third user terminal 100C through the BLE connection [S1101, S1111]. It will be described on the assumption that the photographed image is first transmitted to the third user terminal 100C.

The first user terminal 100A may transmit a photographed video (or a photographed image frame amounting to the number of reference frames) which the first user terminal 100A has photographed to the third user terminal 100C [S1101].

The third user terminal 100A may compare a photographed video received from the first user terminal 100A with a second recorded video recorded by the third user terminal 100A to determine whether there is image identity between the photographed video and the second recorded video [S1102]. In determining the image identity, an image frame or an image hash value may be used as described above.

Since the first user terminal 100A photographs or captures the display screen currently being displayed by the second user terminal 100B, the possibility of the image identity between the image information received from the first user terminal 100A and the image information recorded or captured by the third user terminal 100C is quite low. It is assumed that there is no image identity between them, and the description will be continued.

If it is not approved that there is image identity between them, the third user terminal 100C may transmit an image identity disapproval signal to the first user terminal 100A through the BLE connection [S1103].

The first user terminal 100A may terminate the BLE connection with the third user terminal 100C in response to the image identity disapproval signal [S1104].

The first user terminal 100A may transmit a photographed video (or a photographed image frame amounting to the number of reference frames) which the first user terminal 100A has photographed to the second user terminal 100B [S1111].

The second user terminal 100B may compare the photographed video received from the first user terminal 100A with the first recorded video recorded by the second user terminal 100A to determine whether there is image identity between the photographed video and the first recorded video [S1112]. In determining the image identity, an image frame or an image hash value may be used as described above.

Since the first user terminal 100A photographs or captures the display screen currently being displayed by the second user terminal 100B, there is a high possibility that there is image identity between the image information received from the first user terminal 100A and the image information recorded or captured by the second user terminal 100B. It is assumed that there exists the image identity between them, and the description will be continued.

The existence of the image identity between them may mean that the second user terminal 100B is specified as a target device. When it is approved that the image identity exists, the second user terminal 100B may transmit an image identity approval signal to the second user terminal 100B through the BLE connection [S1113].

The first user terminal 100A may transmit a soft AP access information request signal to the second user terminal 100B through the BLE connection in response to the image identity approval signal [S1114].

The second user terminal 100B may activate its own soft AP function in response to the soft AP access information request signal and transmit information for accessing the activated soft AP to the first user terminal 100A through the BLE connection [S1115, S1116]. If the soft AP function is already activated in the second user terminal 100B, the step S1115 may be omitted. The soft AP access information may include an SSID and a password of the soft AP. The soft AP access information may further include an Internet Protocol (IP) address and a port number.

The first user terminal 100A may terminate the BLE connection with the second user terminal 100B [S1117].

The first user terminal 100A may automatically access the second user terminal 100B, which is the target device, using the soft AP access information [S1118].

At least one of the surrounding environment information and the feature pattern described above may be further utilized in determining the image identity.

Although not shown, if the first user terminal 100A first transmits its photographed video to the second user terminal 100B and then connects to the second user terminal 100B, the first user terminal 100A may terminate the BLE connection with the third user terminal 100C without transmitting its photographed video to the third user terminal 100C.

The present disclosure described above may be implemented with computer-readable codes on a medium in which a program is recorded. Computer-readable media include all kinds of recording devices in which data readable by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, and the like.

What is claimed is:

1. A user terminal, comprising:
a camera;
a wireless communication unit to communicate with an external user terminal; and
a controller configured to:
photograph a screen currently displayed by a first external user terminal among a plurality of external user terminals through the camera,
transmit image information about the photographed screen to a management server or the first external user terminal, and
automatically access the first external user terminal based on access information that is received from the management server or the first external user terminal in response to the transmitted image information about the photographed screen.

2. The user terminal of claim 1, wherein the controller receives the access information from the management server or the first external user terminal based on correlating an image identity between the image information about the photographed screen and a first recorded image information of the first external user terminal.

3. The user terminal of claim 1, wherein based on the first external user terminal being determined to be related to a type of a wireless communication connectible device by recognizing the first external user terminal as an object, the controller controls the image information about the photographed screen to be transmitted to the management server or the first external user terminal.

4. The user terminal of claim 1, wherein the image information about the photographed screen comprises at least one of a photographed video for a reference time, a reference number of photographed image frames, or an image hash value of a photographed image frame.

5. The user terminal of claim 1, the controller controls the image information about the photographed screen to be transmitted together with surrounding environment information.

6. The user terminal of claim 5, wherein the surrounding environment information comprises a surrounding searchable wireless Wi-Fi Access Point (AP) list.

7. The user terminal of claim 1, wherein the image information about the photographed screen comprises a first feature pattern of the first external user terminal.

8. The user terminal of claim 1, wherein the controller controls the user terminal to be registered at a user account in the management server.

9. The user terminal of claim 8, wherein the first external user terminal is registered at the same user account in the management server.

10. The user terminal of claim 1, wherein the access information comprises an Internet Protocol (IP) address and a port number for accessing the first external user terminal.

11. The user terminal of claim 1, wherein the controller performs a first Bluetooth Low Energy (BLE) connection with the first external user terminal based on a first BLE advertisement signal received from the first external user terminal and wherein the controller performs a second BLE connection with a second external user terminal based on a second BLE advertisement signal received from a second external user terminal among a plurality of the external user terminals.

12. The user terminal of claim 11, wherein the controller transmits the image information about the photographed screen to the first external user terminal through the first BLE connection with the first external user terminal and wherein the controller transmits the image information about the photographed screen to the second external user terminal through the second BLE connection with the second external user terminal.

13. The user terminal of claim 11, wherein based on correlating an image identity between the image information about the photographed screen and a first recorded image information of the first external user terminal, the controller receives a soft Access Point (AP) information for accessing the first external user terminal as the access information from the first external user terminal through the first BLE connection and terminals the first BLE connection.

14. The user terminal of claim 11, wherein based on not correlating an image identity between the image information about the photographed screen and a second recorded image information of the second external user terminal, the controller terminates the second BLE connection.

15. The user terminal of claim 1, wherein the user terminal is an Extended Reality (ER) device.

16. A method of controlling a user terminal, the method comprising:
photographing a screen currently displayed by a first external user terminal among a plurality of external user terminals through a camera;
transmitting image information about the photographed screen to a management server or the first external user terminal; and
automatically accessing the first external user terminal based on access information that is received from the management server or the first external user terminal in response to the transmitted image information about the photographed screen.

17. The method of claim 16, further comprising:
receiving the access information from the management server or the first external user terminal based on correlating an image identity between the image information about the photographed screen and a first recorded image information of the first external user terminal.

18. The method of claim 16, further comprising:
based on the first external user terminal being determined to be related to a type of a wireless communication connectible device by recognizing the first external user terminal as an object, transmitting the image information about the photographed screen to the management server or the first external user terminal.

19. The method of claim 16, further comprising:
performing a first Bluetooth Low Energy (BLE) connection with the first external user terminal based on a first BLE advertisement signal received from the first external user terminal; and
performing a second BLE connection with a second external user terminal based on a second BLE advertisement signal received from a second external user terminal among a plurality of the external user terminals.

20. The method of claim 19, wherein the image information about the photographed screen is transmitted to the first external user terminal through the first BLE connection with the first external user terminal and wherein the image information about the photographed screen is transmitted to the second external user terminal through the second BLE connection with the second external user terminal.
